(19) United States
(12) Patent Application Publication
(10) Pub. No.: US 2025/0018374 A1
(43) Pub. Date: Jan. 16, 2025

(54) REGENERATION OF DEGRADED AMINO-SORBENTS FOR CARBON CAPTURE

(71) Applicant: CLIMEWORKS AG, Zurich (CH)

(72) Inventors: Angelo VARGAS, Zurich (CH); Davide ALBANI, Zurich (CH); Claudio LIMONE, Zurich (CH)

(73) Assignee: CLIMEWORKS AG, Zurich (CH)

(21) Appl. No.: 18/711,302

(22) PCT Filed: Nov. 14, 2022
(86) PCT No.: PCT/EP2022/081700

§ 371 Date: May 17, 2024

(30) Foreign Application Priority Data
Nov. 19, 2021 (EP) 21209232.4

(51) Int. Cl. B01J 20/34; B01D 53/62; B01D 53/96; B01J 20/26; B01J 20/28; B01J 20/32

(52) U.S. Cl. CPC B01J 20/3475; B01D 53/62; B01D 53/96; B01J 20/267; B01J 20/28004; B01J 20/28007; B01J 20/28021; B01J 20/28059; B01J 20/28061; B01J 20/28064; B01J 20/28066; B01J 20/321; B01J 20/3217; B01J 20/3253; B01J 20/3425; B01J 20/3458; B01D 2253/202; B01D 2253/304; B01D 2253/306; B01D 2257/504; B01D 2258/06

(57) ABSTRACT

The invention describes a method to regenerate the carbon capture capacity of amino based sorbents used for carbon capture, after they have lost partially or totally their carbon dioxide capture capacity due to oxidation during said carbon capture process.

### TECHNICAL FIELD

The present invention relates to a method to regenerate the sorbent material which is used for carbon dioxide capture, in particular for direct air capture, as well as to a direct air capture process involving corresponding regeneration steps.

### PRIOR ART

According to the OECD report of 2017 [Global Energy & CO2 Status Report 2017, OECD/IEA March 2018] the yearly emissions of CO2 to the atmosphere are ca 32.5 Gt (Gigatons, or 3×109 tons). As of February 2020 all but two of the 196 states that in 2016 have negotiated the Paris Agreement within the United Nations Framework Convention on Climate Change (UFCCC) have ratified it. The meaning of this figure is that a consensus is reached regarding the threat of climate change and regarding the need of a global response to keep the rise of global temperature well below 2 degrees Celsius above pre-industrial levels.

The technical and scientific community engaged in the challenge of proposing solutions to meet the target of limiting CO2 emissions to the atmosphere and to remove greenhouse gases from the atmosphere has envisioned a number of technologies. Flue gas capture, or the capture of CO2 from point sources, such as specific industrial processes and specific CO2 emitters, deals with a wide range of relatively high concentrations of CO2 (3-100 vol %) depending on the process that produces the flue gas. High concentrations make the separation of the CO2 from other gases thermodynamically more favorable and consequently economically favorable as compared to the separation of CO2 from sources with lower concentrations, such as ambient air, where the concentration is in the order of 400 ppmv. Nonetheless, the very concept of capturing CO₂ from point sources has strong limitations: it is specifically suitable to target such point sources, but is inherently linked to specific locations where the point sources are located and can at best limit emissions and support reaching carbon neutrality, while as a technical solution it will not be able to contribute to negative emissions (i.e., permanent removal of carbon dioxide from the atmosphere) and to remove emission from the past. In order to achieve negative emissions (i.e., permanent removal carbon dioxide from the atmosphere), the two most notable solutions currently applied, albeit being at an early stage of development, are the capturing of CO2 by means of vegetation (i.e., trees and plants, but not really permanent removal) using natural photosynthesis, and by means of DAC technologies, which is the only really permanent removal.

Forestation has broad resonance with the public opinion. However, the scope and feasibility of re-forestation projects is debated and is likely to be less simple an approach as believed because it requires a large footprint in terms of occupied surface to captured CO2 ratio. On the other hand, DAC has lower land footprint and therefore it does not compete with the production of crops, can permanently remove CO2 from the atmosphere and can be deployed everywhere on the planet.

The above-described strategies to mitigate climate change all have potential and are considered as a potential part of the overall solution. The most likely future scenario is the deployment of a mix of such approaches, after undergoing further development.

Several DAC technologies were described in expert literature, such as for example, the utilization of alkaline earth oxides to form calcium carbonate as described in US-A-2010034724. Different approaches comprise the utilization of solid CO2 adsorbents, hereafter named sorbents, in the form of packed beds of typically sorbent particles and where CO2 is captured at the gas-solid interface. Such sorbents can contain different types of amino functionalization and polymers, such as immobilized aminosilane-based sorbents as reported in U.S. Pat. No. 8,834,822, and amine-functionalized cellulose as disclosed in WO-A-2012/168346.

WO-A-2011/049759 describes the utilization of an ion exchange material comprising an aminoalkylated bead polymer for the removal of carbon dioxide from industrial applications. WO-A-2016/037668 describes a sorbent for reversibly adsorbing CO2 from a gas mixture, where the sorbent is composed of a polymeric adsorbent having a primary amino functionality. The materials can be regenerated by applying pressure or humidity swing.

Several academic publications, such as Alesi et al. in Industrial & Engineering Chemistry Research 2012, 51, 6907-6915; Veneman et al. in Energy Procedia 2014, 63, 2336; Yu et al. in Industrial & Engineering Chemistry Research 2017, 56, 3259-3269, also investigated in detail the use of cross-linked polystyrene resins functionalized with primary benzyl-amines as solid sorbents for DAC applications.

The state-of-the-art technology to capture CO2 from point sources typically uses liquid amines, as for example in industrial scrubbers, where the flue gas flows into a solution of an amine (U.S. Pat. No. 9,186,617). Other technologies are based on the use of solid sorbents in either a pack-bed or a flow-through structure configuration, where the sorbent is made of impregnated or covalently bound amines onto a support.

Amines react with CO2 to form of a carbamate moiety, which in a successive step can be regenerated to the original amine, for example by increasing the temperature of the sorbent bed to ca 100° C. and therefore releasing the CO2. An economically viable process for carbon capture implies the ability to perform the cyclic adsorption/desorption of CO2 for hundreds or thousands of cycles over the same sorbent material, where the sorbent shall not undergo significant chemical transformations that impedes its reactivity towards CO2. Park et al (Chemical Engineering Journal, Vol. 402 (2020), 126254) report selective capture of CO2 from offgas to be important to mitigate the global warming; and metal organic frameworks (MOFs) have been attractive in the capture because of huge porosity, ready functionalization and so on. In their study, a stable Zr-based MOF, MOF-808, was modified with ethylenediaminetetraacetic acid (EDTA) and further reacted with ethylenediamine (ED); and finally reduced with lithium aluminum hydride (LAH) to introduce several functional groups (FGs) onto the MOF. Moreover, the MOFs were applied in CO2 adsorption under low pressure. The efficiency of MOF-808 in CO2 capture was improved with EDTA loading; however, further reaction of MOF-808-EDTA with ED causes a very much decrease in the efficiency. Importantly, the reduction of MOF-808-EDTA-ED with LAH (for MOF-808-EDTA-ED-R) leads to a remarkable increase in the performance of the MOF, for high CO2 adsorption capacity, CO2/N2 selectivity and isosteric heat of adsorption. For example, MOF-808, MOF-808-EDTA, MOF-808-EDTA-ED and MOF-808-EDTA-ED-R showed CO2/N2 IAST selectivity (from CO2/N2=15/75) of 40, 48, 19 and 197, respectively, under 298 K and 1 atm. This unusual observation could be explained with the contribution of FGs and porosity. Or, amides in cyclic rings might be formed during reaction with ED; and the MOF with amides was poor in CO2 capture partly due to decreased porosity of the MOF; however, can be very effective in adsorption, after further reduction of amides to amines. This work shows the importance of modifications or FGs on MOFs in CO2 adsorption, or a simple reduction can increase the adsorption selectivity as much as 10 times, which might be helpful to mitigate the global warming.

### SUMMARY OF THE INVENTION

Adsorption and desorption cycles of CO2 capture from a gas stream occur in the presence of varying amount of oxygen, and in particular desorption cycles involve a temperature swing, where the sorbent bed is heated to a temperature in the range of 100° C. In such conditions amines can react with oxygen to form adducts. Such adducts have been described in the literature and are depicted in FIG. 1 for the case of linear secondary amines (see in particular A. Ahmadalinezhad, R. Tailor and A. Sayari, Molecular level insights into the oxidative degradation of grafted amines, Chem.—Eur. J., 2013, 19, 10543-10550; A. Ahmadalinezhad and A. Sayari, Oxidative degradation of silica-supported polyethylenimine for CO2 adsorption: insights into the nature of deactivated species, Phys. Chem. Chem. Phys., 2014, 16, 1529-1535; C. S. Srikanth and S. S. C. Chuang, Spectroscopic Investigation into Oxidative Degradation of Silica-Supported Amine Sorbents for CO2 Capture, ChemSusChem, 2012, 5, 1435-1442).

FIG. 2 shows the oxidized species most likely to be found in the case of benzylamine moieties (see e.g. W. Bujis, Direct Air Capture of CO2 with an Amine Resin: A Molecular Modeling Study of the Oxidative Deactivation Mechanism with O2, Ind. Eng. Chem. Res. 2019, 58, 17760-17767; Q. Yu, J. de la P. Delgado, R. Veneman, and D. W. F. Brilman, Stability of a Benzyl Amine Based CO2 Capture Adsorbent in View of Regeneration Strategies, Industrial & Engineering Chemistry Research 2017 56 (12), 3259-3269). Those major products of amine oxidative degradation, namely amide and/or imine functionalities, are suggested to be formed by a mechanism that involves as first event the hydrogen abstraction from the α carbon (see Bollini et al. Oxidative Degradation of Aminosilica Adsorbents Relevant to Postcombustion CO2 Capture Energy Fuels 2011, 25, 2416-2425). The resulting oxidized species in the form of amides and/or imines lose their ability to bind CO2. During a carbon capture process, this is not likely to happen all at once. During multiple cycles, the oxidized species accumulate at the expense of the amines. The amines continue to react with CO2, but their number decreases with time as they are transformed into amides and/or imines. This is associated with a degradation process of the CO2 capturing material because the sorbent gradually decreases its capacity to capture CO2 from the gas stream. When this happens to such an extent that the cost of running the process does not balance the benefit of CO2 extraction, the sorbent material must be exchanged with fresh material. Some authors prepared a sterically hindered alpha bi-methylated primary amine covalently bound to a silica support and claimed that it could have an enhanced oxidative resistance when tested under flue gas capture conditions due to the absence of C—H bonds on its alpha carbon (J. J. Lee, C.-J. Yoo, C.-H. Chen, S. E. Hayes, C. Sievers, C. W. Jones, Silica-Supported Sterically Hindered Amines for CO2 Capture, Langmuir 2018, 34, 12279-12292). In this respect reference is also made to EP 20 186 310.7 and the corresponding PCT/EP 2021/069419 published as WO 2022/013197. All these approaches just identify the problems associated with oxidation, and either propose measures to avoid the problems or the material is replaced after degradation with new one.

There is no existing literature that proposes the regeneration of the amines within carbon dioxide capture sorbents, in order to be able to reuse the sorbent material as a means for carbon capture.

In the following we propose methods of regeneration of amino based sorbent material for carbon dioxide capture, by means of chemical reduction of the oxidized sorbent, in particular by means of a chemical reduction of amides within the sorbent material, as well as uses of such methods for the regeneration of sorbent material having been used as adsorbent for carbon dioxide separation from a gas mixture. Preferably the sorbent material in this context is a purely organic sorbent material in particular without metal building blocks, so preferably the sorbent material is based on an organic polymeric material. Typically, the sorbent material is thus a porous or non-porous material based on an organic polymer material, preferably selected from the group of linear or branched, cross-linked or uncross-linked polystyrene. The invention describes a method to regenerate the carbon capture capacity of amino based sorbents used for carbon capture, after they have lost partially or totally their carbon dioxide capture capacity due to oxidation during said carbon dioxide capture process. The corresponding carbon dioxide capture process, which the material has undergone prior to being subjected to the regeneration process is normally a carbon dioxide capture process involving a heat and/or temperature and/or humidity swing and alternating capture and release steps. So the starting material of the proposed method for a generation is sorbent material which has been used before as adsorbent for carbon dioxide separation from a gas mixture but which has been oxidised due to having been used in this context and typically having lost at least 30% of the initial carbon dioxide capture capacity, preferably at least 40% or at least 50% of the initial carbon dioxide capture capacity.

It is to be noted that in the present context the term “regeneration” of the amino based sorbent material is not referring to the process of releasing carbon dioxide adsorbed by way of the amine moieties in a carbon dioxide capture process. The term “regeneration” is referring to a treatment in which the sorbent material, comprising primary amine or secondary amine moieties or a combination thereof, and having at least partly degraded due to the use in a carbon dioxide capture process involving these amino moieties, to lose the capture ability in particular due to oxidation, is regenerated or converted back chemically such that there are again as many primary amine or secondary amine moieties (or combination thereof) which are available for a preferably cyclic and continuous carbon dioxide capture process again, for example in a process as detailed further below.

Oxidative degradation of primary and secondary amine-based solid sorbents is thought to be initialized by hydrogen abstraction from the α carbon to the amine functionality. The major products of amine oxidative degradation are exemplified in FIGS. 1 and 2.

Once the amine has been oxidatively transformed into an amide, the ability of the nitrogen to bind CO2 is lost. For this reason, the CO2 sorbent material with amides-moieties loses either totally or in only in part its ability to bind CO2, depending on the proportion of amides to amines. If only a part of the amines is transformed to amides, the sorbent capacity is lost in part, while if the oxidation is complete, the sorbent capacity is lost completely. In order to consider a sorbent as degraded, the amines do not have to be completely transformed into amides. In fact, even if only partially transformed into amides with respect to the pristine sorbent material, and if the capacity to capture CO2 is reduced significantly, the efficiency of the carbon capture process can be significantly decreased to compromise the economy of the process. For this reason, sorbent materials can result spent in relatively short times, when the capacity has sunk to a percentage of its original one. In order to continue operations, the sorbent material will need to be replaced entirely.

The present invention focuses on the reduction of the amides to their original state, thus repristinating the original capacity of the material to bind CO2 and allow its reuse within the carbon capture process. The reduction process is performed using one or more reducing agents that are reacted with the amides within the sorbent material. The sorbent material can be suspended or soaked into a solvent together with a reducing agent and/or a catalyst if appropriate. Using apt conditions of temperature and concentration, the amides of the sorbent material are reduced to the original amines. The sorbent material is then rinsed and dried thus eliminating the residuals from the reduction process and the solvents, and the original amines are then again ready for reuse within a carbon capture process. The regeneration of spent amino-based sorbent saves the disposal of the sorbent material, as well as the production costs of new sorbent material.

Before describing the invention, the notation that will be used in the following shall be defined. According to IUPAC nomenclature, the position of the carbon to which the amine is bound is indicated as C(1), or position 1. In a non-IUPAC nomenclature, but often used notation the same carbon is indicated as the alpha carbon, or α-carbon. If multiple amines groups are present on the alkyl chain the IUPAC numbering can change, since such numbering relates to the whole molecule, rather than to a single group, and will change according to the IUPAC rules of priority. In such cases the α-carbon to an amine is not necessarily the C(1). Since when there are multiple amines on an alkyl chain the numbering notation according to IUPAC allows for different numbering of the atoms to which the N is bound, for the present purpose the use of the α-carbon nomenclature is more consistent and will be used.

The term primary amines is used here to designate amines, which have one single alkyl (or aryl or alkyl-aryl) substituent bonded to the nitrogen atom, while the rest of substituents is hydrogen. The term secondary amines is used here to designate amines, which have two alkyl (or aryl) substituents bonded to the nitrogen atom, while one substituent is a hydrogen atom.

Generally speaking, the present invention relates to regenerating material to be used in a method but also relates to regeneration uses of such a method and to such a method for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption using a sorbent material adsorbing said gaseous carbon dioxide in a unit.

According to an aspect of this invention it thus relates to the use of a method as detailed above for the regeneration of sorbent material having been used as adsorbent for carbon dioxide separation from a gas mixture, preferably for the regeneration of sorbent material having been used for separating gaseous carbon dioxide from a gas mixture, from at least one of ambient atmospheric air flue gas and biogas, containing said gaseous carbon dioxide as well as further gases different from gaseous carbon dioxide, by cyclic adsorption/desorption using a sorbent material adsorbing said gaseous carbon dioxide in a unit.

The method in this context comprises at least the following sequential and in this sequence repeating steps (a)-(e):
(a) contacting said gas mixture with the sorbent material to allow at least said gaseous carbon dioxide to adsorb on the sorbent material by flow-through through said unit under ambient atmospheric pressure conditions and ambient atmospheric temperature conditions in an adsorption step (if ambient atmospheric air is pushed through the device using a ventilator for the like, this is still considered ambient atmospheric pressure conditions in line with this application, even if the air which is pushed through the reactor by the ventilator has a pressure slightly above the surrounding ambient atmospheric pressure, and the pressures to is in the ranges as detailed above in the definition of “ambient atmospheric pressures”);
(b) isolating said sorbent material with adsorbed carbon dioxide in said unit from said flow-through, preferably while maintaining the temperature in the sorbent;
(c) inducing an increase of the temperature of the sorbent material, preferably to a temperature between 6° and 110° C., starting the desorption of CO₂ (this is e.g. possible by heat exchangers or by injecting a stream of saturated or superheated steam by flow-through through the unit and thereby inducing an increase of the temperature of the sorbent material to a temperature between 6° and 110° C., starting the desorption of CO₂);
(d) extracting at least the desorbed gaseous carbon dioxide from the unit and separating gaseous carbon dioxide from steam, preferably by condensation, in or downstream of the unit;
(e) bringing the sorbent material to ambient atmospheric temperature conditions (if the sorbent material is not cooled in this step down to exactly the surrounding ambient atmospheric temperature conditions, this is still considered to be according to this step, preferably the ambient atmospheric temperature established in this step (e) is in the range of the surrounding ambient atmospheric temperature+25° C., preferably +10° C. or +5° C.).

According to the invention, the sorbent material regenerated for use or used in such a repeating cycle comprises primary and/or secondary amine moieties immobilized on a solid support.

In the context of this disclosure, the expressions “ambient atmospheric pressure” and “ambient atmospheric temperature” refer to the pressure and temperature conditions to that a plant that is operated outdoors is exposed to, i.e. typically ambient atmospheric pressure stands for pressures in the range of 0.8 to 1.1 barabs and typically ambient atmospheric temperature refers to temperatures in the range of ˜40 to 60° C., more typically −30 to 45° C. The gas mixture used as input for the process is preferably ambient atmospheric air, i.e. air at ambient atmospheric pressure and at ambient atmospheric temperature, which normally implies a CO₂ concentration in the range of 0.03-0.06% by volume. However, also air with lower or higher CO₂ concentration can be used as input for the process, e.g. with a concentration of 0.1-0.5% by volume, so generally speaking, preferably the input CO₂ concentration of the input gas mixture is in the range of 0.01-0.5% by volume. However, also flue gas can be the source, in this case the input CO₂ concentration of the input gas mixture is typically in the range of up to 20% or up to 12% by volume, preferably in the range of 1-20% or 1-12% by volume.

In the above carbon dioxide capture method step sequence (a)-(e), in steps (a) and (e) reference is made to ambient atmospheric pressure conditions and ambient atmospheric temperature conditions. This only applies if the supplied gas mixture is provided under these conditions, for example in case of direct air capture, where the source of the gas mixture is atmospheric air. If however the source of gas mixture is a different source, it may well be that the supply conditions are not ambient atmospheric pressure and/or are not ambient atmospheric temperature conditions. In particular in case of flue gas the gas mixture can be and normally will be at an elevated temperature, for example at a temperature above room temperature, it may even be at a temperature above 50° C. The temperature may even go up to 70° C., and in that case normally the setup is adapted such that the temperature to desorb the carbon dioxide in step (c) is at least 10° C., preferably at least 20° C. higher than that temperature of the supply gas. So under these non-atmospheric temperature and pressure conditions in step (a) and in step (e) normally the pressure and temperature conditions are different, specifically contacting in step (a) takes place under temperature and pressure conditions of the supplied gas mixture, and in step (e) the sorbent is brought to the temperature and pressure conditions of the supplied gas mixture.

According to a first aspect of the present invention, it relates to a method for the regeneration of sorbent material having been used as adsorbent for carbon dioxide separation from a gas mixture, preferably in a method as detailed above. Said sorbent material is comprising primary amine or secondary amine moieties or a combination thereof immobilised on a solid support, wherein preferably the amine moieties in the α-carbon position are substituted by two hydrogen substituents. At least part of the amine moieties due to the use of the sorbent material for carbon dioxide separation preferably in a method as detailed above have been oxidized to amide moieties essentially not participating in the carbon dioxide separation process anymore. According to the invention, said amide moieties are chemically regenerated to primary and/or secondary amine moieties, in which the amine moieties preferably in the α-carbon position are substituted by two hydrogen substituents, to then allow again the use of the sorbent material in a carbon dioxide separation process, preferably in a method as detailed above.

Unexpectedly, it was found that the corresponding material, in the form in which it can be used for carbon dioxide capture processes, can be regenerated chemically without at the same time deteriorating the overall performance in terms of carbon dioxide capture capacity but also in terms of other properties such as mechanical stability and chemical stability. It is therefore surprisingly not necessary, for the regeneration of the sorbent material, to first separate the material into the carrier and the amine carrying moieties, to then reconstitute the primary and/or secondary amine functionality, and to then build the corresponding structure with the carrier again, but it is possible to do that on the very material used for carbon dioxide capture. This is even more surprising in view of the fact that these materials, to be really useful carbon dioxide capture materials need to show a significant porosity and/or particularly high surface area to make available a large number of capture active surface moieties. The proposed regeneration process unexpectedly does not significantly affect any of these mechanical and/or physicochemical properties of the sorbent material structure and allows to selectively reconstitute the reversible carbon dioxide capture property of the sorbent material very efficiently.

The proposed method can be carried out in that chemical regeneration takes place by way of reduction by using stoichiometric reagents or catalytic methods.

Hydrogenation can take place in the liquid phase or at the interface of the liquid and solid phase or in the gas phase or at the interface between the gas and liquid phase or at the interface of the solid and the gas phase.

Preferably, if chemical regeneration takes place by way of hydrogenation using hydrogen gas (H₂), use is made of a catalyst, preferably a bimetallic catalyst. Such reduction is preferably carried out at a hydrogen (partial) pressure of at least 2 bar, preferably of at least 10 bar, more preferably of at least 20 bar, and further preferably at elevated temperature in the range of at least 30° C., preferably of at least 50° C., most preferably at least 60° C.

If the structure in which the carbon dioxide capture process is carried out is suitable and adapted to withstand these regeneration conditions, it is possible to carry out the regeneration process in situ in the device which also is used for the carbon dioxide capture process. This not only applies to the chemical regeneration in the liquid phase or at the interface of the liquid and solid phase but also for the ones in the gas phase.

According to another preferred embodiment of the present invention, chemical regeneration takes place by way of reduction or hydrogenation in the liquid phase or at the interface of the liquid and solid phase, wherein use is made of a metal hydride or a hydrosilane reagent for the reduction or hydrogenation.

If chemical regeneration takes place by way of reduction or hydrogenation using stoichiometric reagents, preferably use is made of a metal hydride for the reduction of the amide, preferably the metal hydride being in the form of aluminium hydride, preferably selected from the group consisting of di-isobutyl aluminium hydride (DIBAL), lithium aluminium hydride (LiAlH4), or a combination thereof. Such a liquid process can be carried out in an organic solvent, in particular THF and/or diethyl ether, typically at elevated temperature, preferably above 40° C., more preferably above 50° C.

According to another preferred embodiment chemical regeneration takes place in the liquid phase or at the interface of the liquid and solid phase, and use is made of a hydrosilane reagent using catalytic hydrosilylation, where the hydrosilane is preferably selected from the group consisting of triethoxysilane, triethylsilan, dimethylphenylsilan, diphenylsilane, 1,1,3,3-tetramethyldisiloxane and polymethylhydrosiloxane, and where the catalyst is preferably selected from at least one carbonyl complex of Ti, Mo, Ru, Os, Fe or a combination thereof.

The sorbent material can take the form of sorbent particles, a porous monolithic structure, or the form of an essentially contiguous adsorbent layer on a solid support carrier structure, or a combination thereof. These structures are the ones used for the actual carbon dioxide capture process, and these structures are not altered for the regeneration process, except for, if needed, removal of the sorbent particles, of the monolithic structure or of the layer on a solid support carrier structure from a device or housing which is used for the carbon dioxide capture process. In case the sorbent material takes the form of sorbent particles, which in a device for carbon dioxide capture are contained in layered elements with a porous grid and/or mesh to contain the sorbent particles, it is possible to just remove these layered elements from the device which is used for the carbon dioxide capture process, and these layered elements can then be directly used in a reactor for regeneration without having to remove the individual sorbent particles from the elements.

According to a preferred embodiment, the sorbent material comprises primary and/or secondary benzylamine moieties or a combination thereof, preferably the carbon dioxide capture moieties of the sorbent material consist of primary benzylamine moieties.

The solid support of the sorbent material is preferably a porous or non-porous material based on an organic and/or inorganic material, preferably a polymer material. A polymer carrier material is preferably selected from the group of linear or branched, cross-linked or uncross-linked polystyrene, polyethylene, polypropylene, polyamide, polyurethane, acrylate-based polymer including PMMA, polyacrylonitrile or combinations thereof, wherein preferably the polymer material is poly(styrene) or poly(styrene-co-divinylbenzene) based, cellulose, or an inorganic material including silica, alumina, activated carbon, metal organic frameworks, covalent organic frameworks and combinations thereof.

According to yet another preferred embodiment, the sorbent material is based on a polystyrene material, preferably cross-linked polystyrene material and most preferably poly(styrene-co-divinylbenzene), which is at least partially functionalized to or contains benzylamine moieties, preferably throughout the material or at least or only on its the surface, wherein preferably the material or the functionalization is obtained by a amidomethylation or a phthalimide or a chloromethylation reaction pathways.

Most preferably, the polymer material is polystyrene/polyvinyl benzene based.

The primary and/or secondary amine moieties and or combination thereof can be part of a polyethyleneimine structure, preferably obtained using aziridine, which is preferably chemically and/or physically attached to the solid support. Such a polyethyleneimine structure can be applied to and immobilized on a corresponding solid support without requiring chemical bonding.

According to a further preferred embodiment, the sorbent material, preferably in porous form, and having specific BET surface area, in the range of 0.5-4000 m2/g or 1-2000 m2/g, preferably 1-1000 m2/g, takes the form of a monolith, the form of a layer or a plurality of layers, the form of hollow or solid fibres, including in woven or nonwoven (layer) structures, or the form of hollow or solid particles. As mentioned above, this structure is maintained during the regeneration process and thereafter.

According to a particularly preferred embodiment, the sorbent material takes the form of preferably essentially spherical beads with a particle size (D50) in the range of 0.002-4 mm, 0.005-2 mm, 0.002-1.5 mm, 0.005-1.6 mm or 0.01-1.5 mm, preferably in the range of 0.30-1.25 mm.

According to another aspect of the present invention, it relates to a method for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption using a sorbent material adsorbing said gaseous carbon dioxide in a unit,
wherein the method comprises at least the following sequential and in this sequence repeating steps (a)-(e):
(a) contacting said gas mixture with the sorbent material to allow at least said gaseous carbon dioxide to adsorb on the sorbent material by flow-through through said unit under ambient atmospheric pressure conditions and ambient atmospheric temperature conditions in an adsorption step;
(b) isolating said sorbent material with adsorbed carbon dioxide in said unit from said flow-through;
(c) inducing an increase of the temperature of the sorbent material to a temperature starting the desorption of CO2;
(d) extracting at least the desorbed gaseous carbon dioxide from the unit and separating gaseous carbon dioxide from steam in or downstream of the unit;
(e) bringing the sorbent material to ambient atmospheric temperature conditions;
wherein said sorbent material comprises primary and/or secondary amine moieties and or combination thereof immobilized on a solid support,
and wherein, after having repeated said sequence of steps a number of times having led to deterioration of the sorbent material due to oxidation, the sorbent material is regenerated using a method of regeneration as described above, and then is continued to be used in the method for separating gaseous carbon dioxide using the above sequence.

Said unit is preferably evacuable to a vacuum pressure of 400 mbar (abs) or less, and step (b) may include isolating said sorbent with adsorbed carbon dioxide in said unit from said flow-through while maintaining the temperature in the sorbent and then evacuating said unit to a pressure in the range of 20-400 mbar (abs), wherein in step (c) injecting a stream of saturated or superheated steam is also inducing an increase in internal pressure of the reactor unit, and wherein step (e) includes bringing the sorbent material to ambient atmospheric pressure conditions and ambient atmospheric temperature conditions.

Again, in the above carbon dioxide capture method step sequence (a)-(e), in steps (a) and (e) reference is made to ambient atmospheric pressure conditions and ambient atmospheric temperature conditions. This only applies if the supplied gas mixture is provided under these conditions, for example in case of direct air capture, where the source of the gas mixture is atmospheric air. If however the source of gas mixture is a different source, it may well be that the supply conditions are not ambient atmospheric pressure and/or are not ambient atmospheric temperature conditions. In particular in case of flue gas the gas mixture can be and normally will be at an elevated temperature, for example at a temperature above room temperature, it may even be at a temperature above 50° C. The temperature may even go up to 70° C., and in that case normally the setup is adapted such that the temperature to desorb the carbon dioxide in step (c) is at least 10° C., preferably at least 20° C. higher than that temperature of the supply gas. So under these non-atmospheric temperature and pressure conditions in step (a) and in step (e) normally the pressure and temperature conditions are different, specifically contacting in step (a) takes place under temperature and pressure conditions of the supplied gas mixture, and in step (e) the sorbent is brought to the temperature and pressure conditions of the supplied gas mixture.

Preferably, after step (d) and before step (e) the following step is carried out:
(d1) ceasing the injection and, if used, circulation of steam, and evacuation of the unit to pressure values between 20-500 mbar (abs), preferably in the range of 50-250 mbar (abs) in the unit, thereby causing evaporation of water from the sorbent and both drying and cooling the sorbent.

Step (e) is preferably carried out exclusively by contacting said ambient atmospheric air with the sorbent material under ambient atmospheric pressure conditions and ambient atmospheric temperature conditions to evaporate and carry away water in the unit and to bring the sorbent material to ambient atmospheric temperature conditions.

After step (b) and before step (c) the following step can be carried out:
(b1) flushing the unit of non-condensable gases by a stream of non-condensable steam while essentially holding the pressure of step (b), preferably holding the pressure of step (b) in a window of ±50 mbar, preferably in a window of ±20 mbar and/or holding the temperature below 75° C. or 70° C. or below 60° C., preferably below 50° C.

In a further embodiment of the step b1, the temperature of the adsorber structure rises from the conditions of step (a) to 80-110° C. preferably in the range of 95-105° C.

In step (b1) the unit can preferably be flushed with saturated steam or steam overheated by at most 20° C. in a ratio of 1 kg/h to 10 kg/h of steam per liter volume of the adsorber structure, while remaining at the pressure of step (b1), to purge the reactor of remaining gas mixture/ambient air. The purpose of removing this portion of ambient air is to improve the purity of the captured CO₂.

In step (c), steam can be injected in the form of steam introduced by way of a corresponding inlet of said unit, and steam can be (partly or completely) recirculated from an outlet of said unit to said inlet, preferably involving reheating of recirculated steam, or by the re-use of steam from a different reactor.

It should be noted that heating for desorption according to this process in step (c) is preferably only affected by this steam injection and there is no additional external or internal heating e.g. by way of tubing with a heat fluid.

In step (c) furthermore preferably the sorbent can be heated to a temperature in the range of 80-110° C. or 80-100° C., preferably to a temperature in the range of 85-98° C.

According to yet another preferred embodiment, in step (c) the pressure in the unit is in the range of 700-950 mbar (abs), preferably in the range of 750-900 mbar (abs).

In such a method preferably regeneration is carried out in situ in the device for separating gaseous carbon dioxide from a gas mixture, or is carried out by taking the support material (individually or in a corresponding cage or secondary carrier structure) out of the device for separating gaseous carbon dioxide from a gas mixture, is regenerated (typically in a corresponding regeneration reactor), and then reintroduced into the device for separating gaseous carbon dioxide to continue the separation process.

Typically, regeneration of the sorbent material is carried out if the carbon dioxide capture capacity has dropped by more than 30%, preferably by more than 20%, more preferably by more than 15% compared with the carbon dioxide capture capacity of pristine sorbent material.

Alternatively or additionally regeneration of the sorbent material is carried out after having cycled the sequence of steps at least 500 times, preferably at least 1000 times, more preferably at least 10,000 times, but preferably before having cycled the sequence of steps 50,000 times, preferably before having cycled the sequence of steps 25,000 times.

Furthermore, the present invention relates to the use of the above regeneration method for generating material which has been used for carbon dioxide capture and shall be used again for carbon dioxide capture.

Also, the present invention relates to material which has been regenerated using a method as described above.

Last but not least, the present invention relates to a device for carrying out a regeneration method as described above.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows the oxidation of linear secondary amines to imines and amides;

FIG. 2 shows the oxidation of primary benzyl-amine to benzamide;

FIG. 3 shows the reduction of amide moieties on oxidative degraded cross linked polystyrene resins using a hydride;

FIG. 4 shows the reduction of amide moieties on oxidative degraded cross linked polystyrene resins using a metal catalyst system and hydrogen; and

FIG. 5 shows a schematic representation of a direct air capture unit.

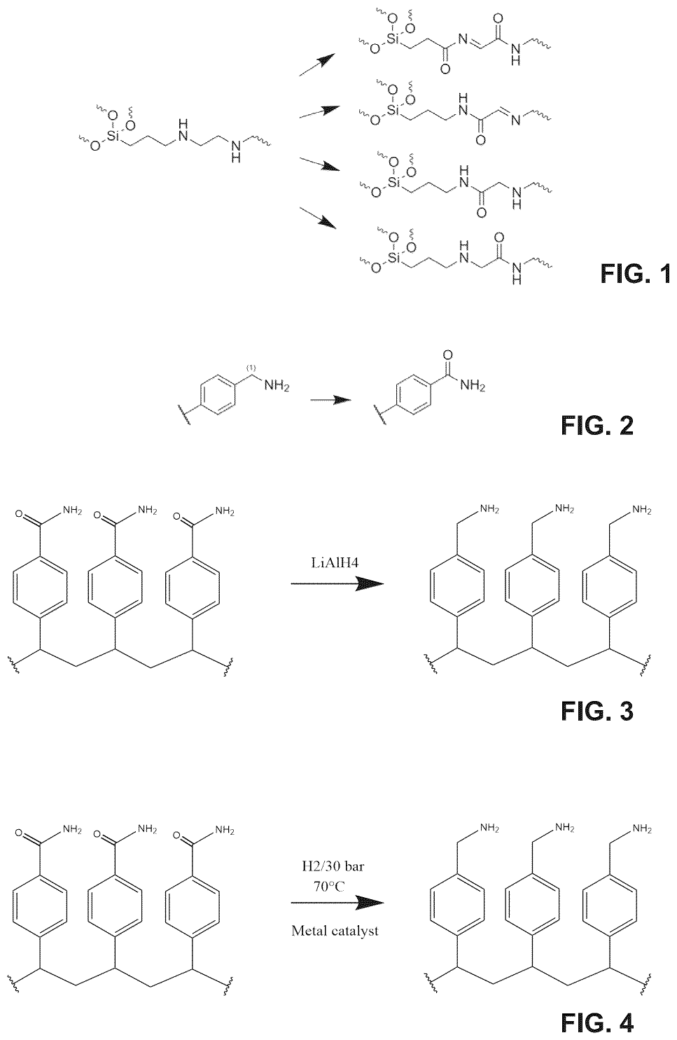

### DESCRIPTION OF PREFERRED EMBODIMENTS

Synthesis Procedure of Styrene-Divinylbenzene Resin Functionalized with Benzylamine Units

In a 1000 ml reactor, 1% (mass ratio) of gelatin and 2% (mass ratio) of sodium chloride are dissolved in 340 cm³ of water at 45° C. for 1 h. In another flask, 1 g of benzoyl peroxide is dissolved in a mixture of 57.8 g of styrene, 5.86 g of divinylbenzene (content 80%) and 63.84 g of C11-C13 isoparaffin. The resulting mixture is then added to the reactor. After that the reaction mixture is stirred and heated up to 70° C. maintaining the temperature for 2 h, then the temperature is raised to 80° C. and kept it for 3 h, and then raised to 90° C. for 6 h. The reaction mixture is cooled down to room temperature and the beads are filtered off using a funnel glass filter and vacuum suction. The beads are washed with toluene and dried in rotavapor.

The polystyrene-divinylbenzene beads are functionalized using the chloromethylation reaction. 5 g of so obtained beads are added to a 3-neck flask containing 50 cm³ of chloromethyl ether. The mixture is stirred for 1 h, 2 g of zinc chloride is added and is heated to 40° C. and kept it for 24 h. After that, the beads are filtered off and wash with 25% HCl and water to obtain chloromethylated beads. To obtain benzylamine units, the chloromethylated beads are aminated using the following procedure. The chloromethylated beads are added to a three-necked flask with 27 g of methylal and the mixture is stirred for 1 h. To this mixture, 16 g of hexamethylenetetramine and 13 g of water are added and kept under gentle reflux for 24 h. The beads are filtered off and washed with water. To have a primary amine, a hydrolysis step followed by a treatment with a bases are required. The beads are placed in a 3-neck flask containing 140 cm³ of a solution of hydrochloric acid (30%)-ethanol (95%) (volume ratio of 1:3), the reaction mixture is heated to 80° C. and kept at this temperature for 20 h. After that, the beads are filtered off and washed with water. At this stage the amine is protonated and to free the base, the beads are treated with 50 cm³ of an NaOH solution 2M, and stirred with 1 h at 80° C. The aminated beads are filter off and washed to neutral pH with demineralized water.

### Example 1

In one embodiment of the invention, we consider cross-linked polystyrene beads functionalized with benzylamine units. The product of degradation of such materials when used for the purpose of capturing CO₂ from air streams is constituted mainly by benzamide moiety, as shown in the scheme of FIG. 2. The benzamide can be reduced to primary benzylamine using LiAlH4 in a solvent using the following protocol and as illustrated in FIG. 3:

10 g of oxidized cross-linked polystyrene beads functionalized with benzylamine units are added into a 200 mL 3-necks round bottom flask. 100 mL of THF are added and the flask is stirred under reflux (66-67° C.) for 1 h to allow the beads to properly swell. 3.9 g of LiAlH4 are added to the flask, the reaction is stirred for 24 h under gentle reflux (66-67° C.). The so regenerated beads are then filtered under vacuum on a Buchner funnel with glass frit and washed with THE followed by cold water.

The resultant cross-linked polystyrene beads functionalized with benzylamine after this reduction showed recovered carbon dioxide capture properties as detailed below up to carbon dioxide capture properties essentially like new beads never having been subjected to carbon dioxide capture processes, and also did not show any other alteration due to the reduction process.

### Example 2

In another embodiment of the invention, the benzamide of the degraded oxidized sorbent is reduced to primary benzylamine using catalytic hydrogenation, with bimetallic catalysts, where the metal can be selected and not limited to groups 6 and 7 and groups 8 to 10, and H₂ and as reducing agent, using the following protocol and as illustrated in FIG. 4:

100 g of oxidized cross-linked polystyrene beads functionalized with benzylamine units are loaded in a stainless-steel autoclave with a Teflon inner cylinder, followed by addition of 0.1 g of V-modified Pt nanoparticles in 1,2-dimethoxyethane. The autoclave was sealed and flushed with N2 to remove air from the reactor. After that 30 bar of H₂ were introduced in the reactor and the temperature was risen to 70° C. The reaction mixture was kept at 70° C. for 1 h. The autoclave was then cooled to room temperature and the H₂ pressure released. The beads were then filtered off and wash with water.

The resultant cross-linked polystyrene beads functionalized with benzylamine after this reduction showed recovered carbon dioxide capture properties as detailed below up to carbon dioxide capture properties essentially like new beads never having been subjected to carbon dioxide capture processes, and also did not show any other alteration due to the reduction process.

### Example 3

In another embodiment of the invention, we consider the reduction of the benzamide moiety to benzylamine using hydrosilylation, where the silane can be but is not restricted to triethoxysilane, triethylsilan, dimethylphenylsilan, diphenylsilane, 1,1,3,3-tetramethyldisiloxane and polymethylhydrosiloxane, and where the catalyst can be but not limited to a carbonyl complex of Ti, Mo, Ru, Os, Fe, using the following protocol:

10 g of oxidized cross-linked polystyrene beads functionalized with benzylamine units are loaded in a 200 mL three-neck round bottom flask. The beads are swollen by adding 50 g of toluene and are left under stirring for 2 h. The round bottom flask is flushed with N2. To the swollen beads, 0.05 g of triruthenium dodecacarbonyl or iron dodecacarbonyl and 60 g 1,1,3,3-tetramethyldisiloxane (TMDS) are added and left under stirring for 30 min. After that the reaction mixture is heated up to 70° C. and left it at this temperature for 24 h. The reaction mixture is cooled down to room temperature and the beads are filtered off, rinsed with methanol and water.

The resultant cross-linked polystyrene beads functionalized with benzylamine after this reduction showed recovered carbon dioxide capture properties as detailed below up to carbon dioxide capture properties essentially like new beads never having been subjected to carbon dioxide capture processes, and also did not show any other alteration due to the reduction process.

### Carbon Dioxide Capture Properties:

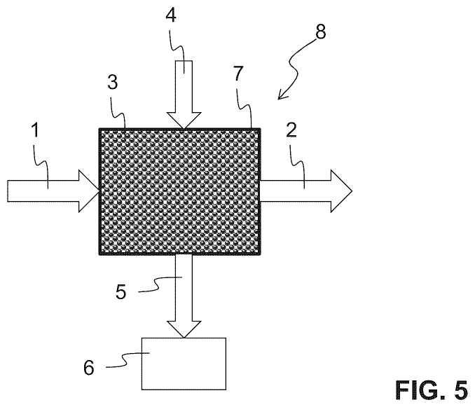

The beads according to the above examples were tested in an experimental rig in which the beads were contained in a packed-bed reactor or in air permeable layers. The rig is schematically illustrated in FIG. 5. There is an ambient air inflow structure 1 and the actual reactor unit 8 comprises a container or wall 7 within which the layers of sorbent material 3 are located. There is an inflow structure 4 for desorption, if for example steam is used for desorption, and there is a reactor outlet 5 for extraction. Further, there is a vacuum unit 6 for evacuating the reactor.

For the adsorption measurements, 6 g of dry sample was filled into a cylinder with an inner diameter of 40 mm and a height of 40 mm and placed into a CO₂ adsorption/desorption device, where it was exposed to a flow of 2.0 NL/min of air at 30° C. containing 450 ppmv CO₂, having a relative humidity of 60% corresponding to a temperature of 30° C. for a duration of 600 min. Prior to adsorption, the sorbent bed was desorbed by heating the sorbent to 94° C. under an air flow of 2.0 NL/min. The amount of CO₂ adsorbed on the sorbent was determined by integration of the signal of an infrared sensor measuring the CO₂ content of the air stream leaving the cylinder.

The adsorber structure can alternatively be operated using a temperature/vacuum swing direct air capture process involving temperatures up to and vacuum pressures in the range of 50-250 mbar (abs) and heating the sorbent to a temperature between 6° and 110° C. In addition, experiments involving steam were carried out, with or without vacuum.

From the experiments one can see that the adsorption characteristics are reestablished after the regeneration process.

LIST OF REFERENCE SIGNS

| | |
|---|---|
| 1 | ambient air, ambient air |
| | inflow structure |
| 2 | outflow of ambient air behind |
| | adsorption unit in adsorption |
| | flow-through mode |
| 3 | sorbent material |
| 4 | steam, steam inflow structure |
| | for desorption |
| 5 | reactor outlet for extraction |
| 6 | vacuum unit/separator |
| 7 | wall |
| 8 | reactor unit |

1. Method for the regeneration of sorbent material having been used as adsorbent for carbon dioxide separation from a gas mixture,
said sorbent material comprising primary amine or secondary amine moieties, or a combination thereof, immobilised on a solid support, and wherein at least part of the amine moieties due to the use of the sorbent material for carbon dioxide separation have been oxidized to amide moieties essentially not participating in the carbon dioxide separation process anymore,
wherein said amide moieties are chemically regenerated to primary and/or secondary amine moieties or mixture thereof.

2. Method according to claim 1, wherein chemical regeneration takes place by reduction using at least one of stoichiometric reagents and/or or hydrogenation using catalytic methods.

3. Method according to claim 1, wherein chemical regeneration takes place by way of hydrogenation, wherein use is made of a catalyst, using hydrogen gas (H₂).

4. Method according to claim 1, wherein chemical regeneration takes place by way of reduction in the liquid phase or at the interface of the liquid and solid phase, wherein use is made of a metal hydride or a hydrosilane reagent for the reduction.

5. Method according to claim 1, wherein chemical regeneration takes place by way of reduction in the liquid phase or at the interface of the liquid and solid phase, wherein use is made of a metal hydride.

6. Method according to claim 1, wherein chemical regeneration takes place by reduction in the liquid phase or at the interface of the liquid and solid phase, wherein use is made of a hydrosilane reagent using catalytic hydrosilylation.

7. Method according to claim 1, wherein the sorbent material takes the form of sorbent particles, a porous monolithic structure, or the form of an essentially contiguous adsorbent layer on a solid support carrier structure, or a combination thereof.

8. Method according to claim 1, wherein the amine moieties in the α-carbon position are substituted by two hydrogen substituents.

9. Method according to claim 1, wherein the solid support of the sorbent material is a porous or non-porous material based on an organic and/or inorganic material.

10. Method according to claim 1, wherein the primary and/or secondary amine moieties are part of a polyethyleneimine structure.

11. Method according to claim 1, wherein the sorbent material takes the form of a monolith, the form of a layer or a plurality of layers, the form of hollow or solid fibres, including in woven or nonwoven (layer) structures, or the form of hollow or solid particles.

12. Method according to claim 1, wherein the sorbent material takes the form beads with a particle size (D50) in the range of 0.002-4 mm, 0.005-2 mm, 0.002-1.5 mm, 0.005-1.6 mm or 0.01-1.5 mm.

13. Method of using a method according to claim 1 for the regeneration of sorbent material having been used as adsorbent for carbon dioxide separation from a gas mixture,
for the regeneration of sorbent material having been used for separating gaseous carbon dioxide from a gas mixture, from at least one of ambient atmospheric air, flue gas and biogas, containing said gaseous carbon dioxide as well as further gases different from gaseous carbon dioxide, by cyclic adsorption/desorption using a sorbent material adsorbing said gaseous carbon dioxide in a unit,
wherein the method comprises at least the following sequential and in this sequence repeating steps (a)-(e):
(a) contacting said gas mixture with the sorbent material to allow at least said gaseous carbon dioxide to adsorb on the sorbent material by flow-through through said unit, in case of ambient atmospheric air as gas mixture under ambient atmospheric pressure conditions and ambient atmospheric temperature conditions and in other cases under temperature and pressure conditions of the supplied gas mixture, in an adsorption step;
(b) isolating said sorbent material with adsorbed carbon dioxide in said unit from said flow-through;
(c) inducing an increase of the temperature of the sorbent material to a temperature starting the desorption of CO₂;
(d) extracting at least the desorbed gaseous carbon dioxide from the unit and separating gaseous carbon dioxide from steam in or downstream of the unit;
(e) bringing the sorbent material, in case of ambient atmospheric air as gas mixture, to ambient atmospheric temperature conditions, and in other cases to the temperature and pressure conditions of the supplied gas mixture;
wherein said sorbent material comprises primary and/or secondary amine moieties or a combination thereof immobilized on a solid support.

14. A method for separating gaseous carbon dioxide from a gas mixture, including from at least one of ambient atmospheric air, flue gas and biogas, containing said gaseous carbon dioxide as well as further gases different from gaseous carbon dioxide, by cyclic adsorption/desorption using a sorbent material adsorbing said gaseous carbon dioxide in a unit,
wherein the method comprises at least the following sequential and in this sequence repeating steps (a)-(e):
(a) contacting said gas mixture with the sorbent material to allow at least said gaseous carbon dioxide to adsorb on the sorbent material by flow-through through said unit, in case of ambient atmospheric air as gas mixture under ambient atmospheric pressure conditions and ambient atmospheric temperature conditions and in other cases under temperature and pressure conditions of the supplied gas mixture, in an adsorption step;
(b) isolating said sorbent material with adsorbed carbon dioxide in said unit from said flow-through;
(c) inducing an increase of the temperature of the sorbent material to a temperature starting the desorption of CO₂;
(d) extracting at least the desorbed gaseous carbon dioxide from the unit and separating gaseous carbon dioxide from steam in or downstream of the unit;
(e) bringing the sorbent material, in case of ambient atmospheric air as gas mixture, to ambient atmospheric temperature conditions, and in other cases to the temperature and pressure conditions of the supplied gas mixture;
wherein said sorbent material comprises primary and/or secondary amine moieties or a combination thereof immobilized on a solid support,
and wherein, after having repeated said sequence of steps a number of times having led to deterioration of the sorbent material due to oxidation, the sorbent material (3) is regenerated using a method according to claim 1, and then is continued to be used in the method for separating gaseous carbon dioxide using the above sequence.

15. Method according to claim 14, wherein regeneration is carried out in situ in the device for separating gaseous carbon dioxide from a gas mixture, or is carried out by taking the sorbent material/support material out of the device for separating gaseous carbon dioxide from a gas mixture, is regenerated, and then reintroduced into the device for separating gaseous carbon dioxide to continue the separation process.

16. Method according to claim 14, wherein regeneration of the sorbent material is carried out if the carbon dioxide capture capacity has dropped by more than 30%, or by more than 20%, or by more than 15% compared with the carbon dioxide capture capacity of pristine sorbent material,
or wherein regeneration of the sorbent material is carried out after having cycled the sequence of steps at least 500 times, or at least 1000 times, or at least 10,000 times.

17. Method according to claim 1, wherein chemical regeneration takes place by way of hydrogenation, wherein use is made of a bimetallic catalyst, using hydrogen gas (H₂), at a pressure of at least 2 bar, or of at least 10 bar, or of at least 20 bar, and at elevated temperature in the range of at least 30° C., or of at least 50° C., or at least 60° C.

18. Method according to claim 1, wherein chemical regeneration takes place by way of reduction in the liquid phase or at the interface of the liquid and solid phase, wherein use is made of a metal hydride, in the form of aluminium hydride, including those selected from the group consisting of di-isobutyl aluminium hydride (DIBAL), lithium aluminium hydride (LiAlH₄), or a combination thereof, in an organic solvent, including THF and/or diethylether, at elevated temperature, including above 40° C., or above 50° C.

19. Method according to claim 1, wherein chemical regeneration takes place by reduction in the liquid phase or at the interface of the liquid and solid phase, wherein use is made of a hydrosilane reagent using catalytic hydrosilylation, where the hydrosilane is selected from the group consisting of triethoxysilane, triethylsilan, dimethylphenylsilan, diphenylsilane, 1,1,3,3-tetramethyldisiloxane and polymethylhydrosiloxane, and where the catalyst can be selected from at least one carbonyl complex of Ti, Mo, Ru, Os, Fe or a combination thereof.

20. Method according to claim 1, wherein the amine moieties in the α-carbon position are substituted by two hydrogen substituents, wherein the sorbent material comprises primary and/or secondary benzylamine moieties.

21. Method according to claim 1, wherein the carbon dioxide capture moieties of the sorbent material consist of primary benzylamine moieties.

22. Method according to claim 1, wherein the solid support of the sorbent material is a porous or non-porous material based on an organic and/or inorganic material, namely a polymer material, selected from the group of linear or branched, cross-linked or uncross-linked polystyrene, polyethylene, polypropylene, polyamide, polyurethane, acrylate-based polymer including PMMA, polyacrylonitrile or combinations thereof, including polymer material selected as poly(styrene) or poly(styrene-co-divinylbenzene) based, cellulose, or an inorganic material including silica, alumina, activated carbon, metal organic frameworks, covalent organic frameworks, and combinations thereof,
and/or wherein the sorbent material is based on a polystyrene material, including cross-linked polystyrene material and poly(styrene-co-divinylbenzene), which is at least partially functionalized to or contains benzylamine moieties, throughout the material or at least or only on its the surface, wherein the material or the functionalization can be obtained by amidomethylation or phthalimide or chloromethylation reaction pathways or a combination thereof.

23. Method according to claim 1, wherein the primary and/or secondary amine moieties are part of a polyethyleneimine structure, obtained using aziridine, which is chemically and/or physically attached to a solid support.

24. Method according to claim 1, wherein the sorbent material, in porous form, and having specific BET surface area, in the range of 0.5-4000 m²/g or 1-2000, or 1-1000 m²/g, takes the form of a monolith, the form of a layer or a plurality of layers, the form of hollow or solid fibres, including in woven or nonwoven (layer) structures, or the form of hollow or solid particles.

25. Method according to claim 1, wherein the sorbent material takes the form of essentially spherical beads with a particle size (D50) in the range of 0.002-4 mm, 0.005-2 mm, 0.002-1.5 mm, 0.005-1.6 mm or 0.01-1.5 mm, or in the range of 0.30-1.25 mm.
